(19) United States
(12) Patent Application Publication
(10) Pub. No.: US 2020/0221894 A1
(43) Pub. Date: Jul. 16, 2020

(54) CORN KERNAL HARVESTING APPARATUS

(71) Applicants: Verne Scott Coulter, Langley (CA); Christine Coulter, Langley (CA)

(72) Inventors: Verne Scott Coulter, Langley (CA); Christine Coulter, Langley (CA)

(21) Appl. No.: 16/245,195

(22) Filed: Jan. 10, 2019

(51) Int. Cl. A47J 17/02; A01F 5/00

(52) U.S. Cl. CPC A47J 17/02; A01F 5/00

(57) ABSTRACT

A corn kernel harvester apparatus having a handle and a harvesting housing. The harvesting housing has an elongated tubular body having an entry end and a handle end. The tubular body defining a longitudinal axis. The housing has an interior chamber therein dimensioned to receive a corncob. The handle end is fastened to the handle. The entry end has a circular opening that is defined by an edge, such that when an ear of corn passes through the entry opening, corn kernels meet resistance from the edge causing the corn kernels to detach from the corncob while allowing the cleaned corncob to pass therethrough into the interior chamber.

### REFERENCE TO PENDING APPLICATIONS

This application does not claim the benefit of any issued U.S. Patent or pending application.

### TECHNICAL FIELD

The present invention relates generally toward the harvesting of corn kernels, and specifically, toward a device for removing corn kernels from a corncob.

### BACKGROUND

An ear of corn includes a corncob which is the central core and a plurality of kernels. The cob is the part of the ear on which the kernels grow. At times, it is desirable to remove the kernels from the cob, such as when preparing corn for canning or in the preparation of culinary dishes.

The act of removing corn kernels from a corncob can be time-consuming, can potentially damage the corn kernels or injure the person who is removing the kernels. The prior art acts of removing kernels may include cutting the kernels free from the cob with a knife or other sharp object. The use of such implements can lead to injury by the user as well as damage to the corn kernels.

There are prior art tools designed to remove the kernels from the cob. These tools, however, have challenges. One prior art tool has been referred to as a corn stripper. This prior art tool includes a metal ring with a serrated edge on a handle that passes along the ear of corn, cuts kernels away from the cob as it passes between the kernels and the cob. This prior art tool has a disadvantage in that is can be dangerous to use as the user's hands are close to serrated edge. Due to the lack of stability with cob as this tool passes over the cob can cause inadvertent contact by the user's hands with the serrated edge causing injury.

Another prior art tool is referred to as a corn peelers, which is designed similarly to a vegetable peeler, with a blade that passes between the kernels and cob cutting the kernels away. The prior art tool also has a disadvantage in that it is slow to use and not that efficient. By having to cut multiple strips of kernels away for each ear of corn the user must take a significant amount to time to remove the kernels from a single ear of corn. Further, this tool can be dangerous as user's hand is close to the cutting edge.

Accordingly, there is a need to satisfy the challenges set out above.

### SUMMARY

The present invention relates generally toward the harvesting of corn kernels, and specifically, toward a device for removing corn kernels from a corncob.

In one aspect, a corn kernel harvester apparatus has a handle and a harvesting housing. The harvesting housing has an elongated tubular body having an entry end and a handle end. The tubular body defines a longitudinal axis. The housing has an interior chamber dimensioned to receive a corncob. The handle end is fastened to the handle. The entry end has an edge defining a circular opening. In some aspects, the handle end has an exit opening allowing the cleaned corncob to be removed from the interior chamber. Further, in some aspects, the handle and the harvesting housing are a unitary unit, while in some aspects the handle is removably attachable to the harvesting housing.

In operation, when an ear of corn passes through the entry opening, corn kernels meet resistance from the edge of the entry opening. This causes the corn kernels to detach from the corncob while allowing the cleaned corncob to pass therethrough into the interior chamber.

In one aspect, a method for removing corn kernels from a corncob of an ear of corn using a corn kernel harvester apparatus as set above includes placing an ear of corn in a vertical position, aligning the harvester apparatus at the upper end of the ear of corn and depressing the harvester apparatus down through the ear of corn along the longitudinal axis detaching the corn kernels from the corncob, wherein the cleaned corncob is deposited at least partially within the interior chamber of the harvester.

Other aspects and features of the present invention will become apparent to those ordinarily skilled in the art upon review of the following description of specific embodiments of the invention in conjunction with the accompanying figures.

### BRIEF DESCRIPTION OF THE DRAWING

In drawings which illustrate embodiments of the invention wherein similar characters of reference denote corresponding parts in each view,

FIG. 1 is a side view of an embodiment of the present invention.

FIG. 2 is a side cut-away view of an embodiment of the present invention.

FIG. 3 is a side cut-away view of an embodiment of present invention in use.

FIG. 4 is a side cut-away view of an embodiment of the entry end of present invention.

FIG. 5 is a bottom view of an embodiment of the entry end of present invention.

FIG. 6 is a flowchart of an embodiment of a method of present invention.

### DETAILED DESCRIPTION OF THE INVENTION

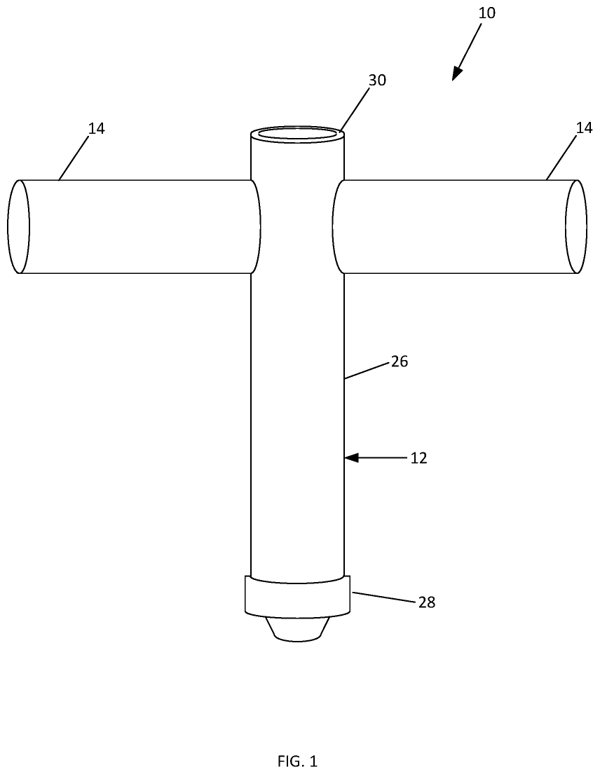

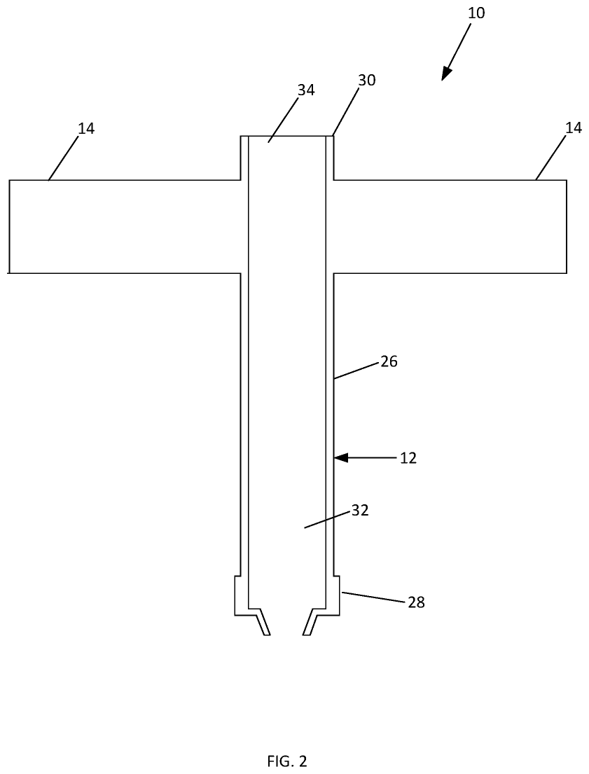

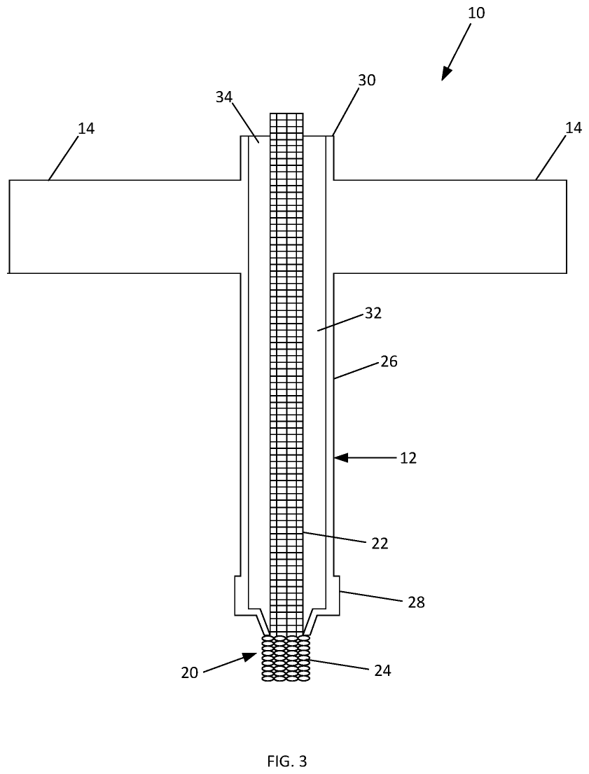

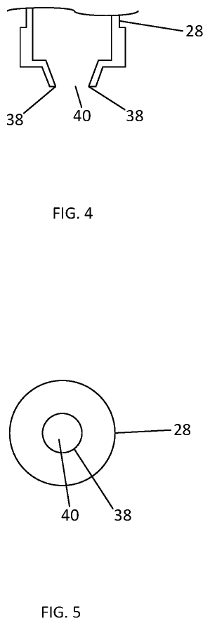

As illustrated in FIGS. 1 to 5, an embodiment of a corn kernel harvester apparatus 10 is disclosed. Harvester 10 is designed to remove corn kernels 24 from the corncob 22 portion of an ear of corn 20 by moving harvester 10 longitudinally along the ear of corn 20, and the process, forcing the corn kernels 24 away from the corncob 22.

In this embodiment, harvester 10 includes a harvester housing 12 and a handle 14. In this embodiment, handle 14 and housing 12 are illustrated as being unitary. However, this is illustrative and is not meant to be limiting. Those skilled in the art will recognize that handle 14 and housing 12 may be separate components that may be detachable from each other. Further, housing 12 and handle 14 are also illustrated as being circular in dimension. This is also illustrative. Those skilled in the art will recognize that additional configurations are within the scope of the present invention.

Harvester housing 12 has an elongated tubular body 26 defining a longitudinal axis. Elongated body 26 has an entry end 28 and a handle end 30. Further, housing 12 has an interior chamber 32 which is dimensioned to receive at least part of the corncob.

The handle may be attached to the housing 12 near the handle end 30 allowing for sufficient force to be applied to push housing 12 against the ear of corn 20. In this embodiment, handle 14 is secured to handle end 30 in a “T” configuration. This is illustrative and not meant to be limiting. Those skilled in the art will recognize that handle 14 may be attached to housing 12 in other configurations such that handle 14 may be utilized to exert the sufficient amount of force to move the harvester 10 longitudinally along the ear of corn 20.

Entry end 28 has an edge 38 that defines a circular opening 40. Opening 40 has a diameter that can allow corncob 22 to pass therethrough but not the attached corn kernels 24.

Handle end 30 has an exit opening 34 to allow a cleaned corncob 22 to be removed from the interior chamber 32. Housing 12 is sufficiently elongated to allow at least a portion of cleaned corncob 22 to remain in interior chamber 32 while having a portion extend beyond handle end 30. This provides support to the ear of corn 20 while it is undergoing the kernel removal process, while protecting the user for accidental contact with the edge of entry end.

In operation, when the ear of corn 20 passes through the entry opening 28, corn kernels 24 meet resistance from edge 38 causing corn kernels 24 to detach from corncob 22 while allowing the cleaned corncob 22 to pass therethrough into the interior chamber 32. The detached corn kernels 24 remain on the outside of harvester housing 12.

As illustrated in FIG. 6, an embodiment of the method 100 of the present invention. The method utilizes a corn kernel harvester apparatus as set above. The method 100 includes placing 110 the ear of corn 20 in a vertical position. The ear of corn 20 has previously had its stalk end cut flat so that the ear of corn 20 may stand flat on a surface. The harvester 10 is aligned 120 at the upper end of the ear of corn 20. The harvester 10 is depressed 130 down through the ear of corn 20 along the longitudinal axis detaching the corn kernels 24 from the corncob 22. The cleaned corncob 22 is deposited at least partially within the interior chamber 32 of the harvester housing 12.

While preferred embodiments of the present inventive concept have been shown and disclosed herein, it will be obvious to those persons skilled in the art that such embodiments are presented by way of example only, and not as a limitation to the scope of the inventive concept. Variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

I claim:

1. A corn kernel harvester apparatus comprising:
a handle; and
a harvesting housing, the harvesting housing having
an elongated tubular body having an entry end and a handle end and defining a longitudinal axis, the housing having an interior chamber therein dimensioned to receive a corncob,
the handle end being fastened to the handle,
the entry end having an edge and defining a circular opening,
whereby when an ear of corn passes through the entry opening, corn kernels meet resistance from the edge of the entry opening causing the corn kernels to detach from the corncob while allowing the cleaned corncob to pass therethrough into the interior chamber.

2. The corn kernel harvester apparatus of claim 1, wherein handle end comprises an exit opening, whereby the cleaned corncob may be removed from the interior chamber.

3. The corn kernel harvester apparatus of claim 1, wherein the handle and the harvesting housing are a unitary unit.

4. The corn kernel harvester apparatus of claim 1, wherein the handle is removably attachable to the harvesting housing.

5. A method for removing corn kernels from a corncob of an ear of corn using a corn kernel harvester apparatus having a handle, and a harvesting housing, the harvesting housing having an elongated tubular body having an entry end and a handle end and defining a longitudinal axis, the housing having an interior chamber therein dimensioned to receive a corncob, the handle end being fastened to the handle, the entry end having an edge and defining a circular opening, whereby when an ear of corn passes through the entry opening, corn kernels meet resistance from the edge of the entry opening causing the corn kernels to detach from the corncob while allowing the cleaned corncob to pass therethrough into the interior chamber, the method comprising the steps of:
placing an ear of corn in a vertical position;
aligning the harvester apparatus at the upper end of the ear of corn;
depressing the harvester apparatus down through the ear of corn along the longitudinal axis detaching the corn kernels from the corncob, wherein the cleaned corncob is deposited at least partially within the interior chamber of the harvester.
